(19) United States
(12) Patent Application Publication
(10) Pub. No.: US 2010/0108595 A1
(43) Pub. Date: May 6, 2010

(54) Strainer

(75) Inventor: RAYMOND V. HEELAN, JR., WARREN, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ALLEGHENY VALVE AND COUPLING, INC., WARREN, PA (US)

(21) Appl. No.: 12/613,871

(22) Filed: Nov. 6, 2009

Related U.S. Application Data
(60) Provisional application No. 61/111,909, filed on Nov. 6, 2008.

(51) Int. Cl. B01D 29/15

(52) U.S. Cl. 210/433.1

(57) ABSTRACT

A straight strainer assembly for removing particle contaminants from a fluid flow includes a first body extending along a first longitudinal axis and a second body attached to the first tubular body. The second tubular body extends along a second longitudinal axis that is not parallel to the first longitudinal axis. A cylindrical strainer basket extends through the second hollow internal cavity from the second end of the second tubular body into the first hollow internal cavity. A retainer ring is disposed within the first tubular body and has an elliptical face portion extending obliquely within the first tubular.

### CROSS-REFERENCE TO RELATED APPLICATIONS

The present application claims priority from U.S. Provisional Patent Application No. 61/111,909, filed Nov. 6, 2008, which is incorporated herein by reference in its entirety.

### BACKGROUND OF THE INVENTION

1. Field of the Invention

The present invention relates to a strainer. More specifically, the present invention relates to a straight strainer assembly having a strainer basket and an elliptical retainer ring for the basket that includes perforations matching the perforations in the strainer basket, such that liquid flowing through the strainer assembly may be strained by both the basket and the retainer ring.

2. Description of Related Art

Conventional straight strainer assemblies include a first, straight tubular body and a second tubular body attached to the first tubular body and branching therefrom at an angle, typically 45°. Such conventional strainer assemblies require that two T-shaped sections of conduit be cut through with a template and then re-assembled by welding to create a 45° lateral conduit. The lateral conduit is then assembled into a straight strainer by the addition of a flange at the end of the branched tubular body with a blind flange having a round retainer ring welded to its inside. The round retainer ring is designed to hold the round perforated or mesh basket, which is also held at the opposite, straight end by a retainer ring.

Such conventional strainer assemblies have suffered from several drawbacks. First, manufacture of the assembly requires the cannibalization of two T-shaped sections of conduit, which leads to material waste, significant assembly time, and increased manufacturing costs. Further, the welded connection between the welded components creates a structural weakness in the assembly, leading to increased weight and a reduced operational lifespan. Finally, the retainer ring does not participate in the straining function of the assembly, thus reducing the flow rate of liquid flowing through the assembly.

### SUMMARY OF THE INVENTION

Accordingly, there is a general need in the art for a straight strainer assembly that reduces material and manufacturing costs, has increased strength, lighter weight and operational lifespan, and also provides a larger flow area as compared to conventional assemblies.

According to a preferred non-limiting embodiment of the present invention, a straight strainer assembly is provided. The straight strainer assembly includes a first tubular body extending along a first longitudinal axis between a first open end and a second open end, the first tubular body having a first sidewall defining a first hollow internal cavity; a second tubular body integrally formed with or attached to the first tubular body between the first and second ends of the first tubular body, the second tubular body extending along a second longitudinal axis that is not parallel with the first longitudinal axis, the second tubular body extending between a first open end at least partially joined to the sidewall of the first tubular body and a second open end, and the second tubular body having a second sidewall defining a second hollow internal cavity in communication with the first hollow internal cavity of the first tubular body; a cylindrical strainer basket extending at least partially through the second hollow internal cavity from the second end of the second tubular body into the first hollow internal cavity; and a retainer ring disposed within the first tubular body and having an elliptical face portion extending obliquely within the first tubular body.

In a further preferred and non-limiting embodiment, the retainer ring includes a sidewall portion that extends transversely from the elliptical face portion for at least partially engaging a first end of the cylindrical strainer basket within the first tubular body to maintain a position of the cylindrical strainer basket. The second longitudinal axis forms an angle of less than about 90°, and in one preferred and non-limiting embodiment, an angle of about 45° with the first longitudinal axis.

In a further preferred and non-limiting embodiment, the second tubular body includes a flange disposed on the second end thereof, and the assembly further includes a blind flange secured to the flange of the second tubular body to close the second hollow internal cavity at the second end of the second tubular body; and a gasket disposed between the flange on the second tubular body and the blind flange for sealing an engagement between the second tubular body and the blind flange. The cylindrical strainer basket may be formed from a screen having perforations and arranged in a tubular configuration. The elliptical face portion of the retainer ring can have perforations corresponding in size to the perforations in the screen of the cylindrical strainer basket. The elliptical face portion of the retainer ring at least partially engages an inner perimeter of the first sidewall.

In another preferred and non-limiting embodiment, the assembly further includes a cap retainer disposed within the second tubular body at the second end thereof and engaging a second end of the cylindrical strainer basket to maintain the position of the cylindrical strainer basket. Both the cylindrical strainer basket and the elliptical face portion of the retainer ring strain liquid flowing through the strainer assembly.

According to a further preferred and non-limiting embodiment of the present invention, a retainer ring for maintaining a position of a strainer basket in a straight strainer is provided. The retainer ring includes an elliptical face portion adapted to extend obliquely within the straight strainer to engage an inner perimeter of the straight strainer. In another preferred and non-limiting embodiment, the retainer ring extends includes a sidewall portion that extends transversely from the elliptical face portion and is adapted to engage the strainer basket within a straight strainer to maintain a position of the cylindrical strainer basket. The elliptical face portion includes perforations adapted to strain liquid flowing through the straight strainer.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a strainer assembly according to an embodiment of the present invention.

FIG. 2 is a left side view of the strainer assembly of FIG. 1.

FIG. 3 is a bottom view of the strainer assembly of FIG. 1.

FIG. 4 is a cross-sectional side view of the strainer assembly according to line A-A shown in FIG. 3.

FIG. 5 is a bottom perspective view of a retainer ring of the strainer assembly according to an embodiment of the present invention.

FIG. 6 is a top plan view of the retainer ring of FIG. 5.

FIG. 7 is a cross-sectional side view of the retainer ring according to line B-B shown in FIG. 6.

FIG. 8 is a perspective view of a strainer basket of the strainer assembly.

### DESCRIPTION OF PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

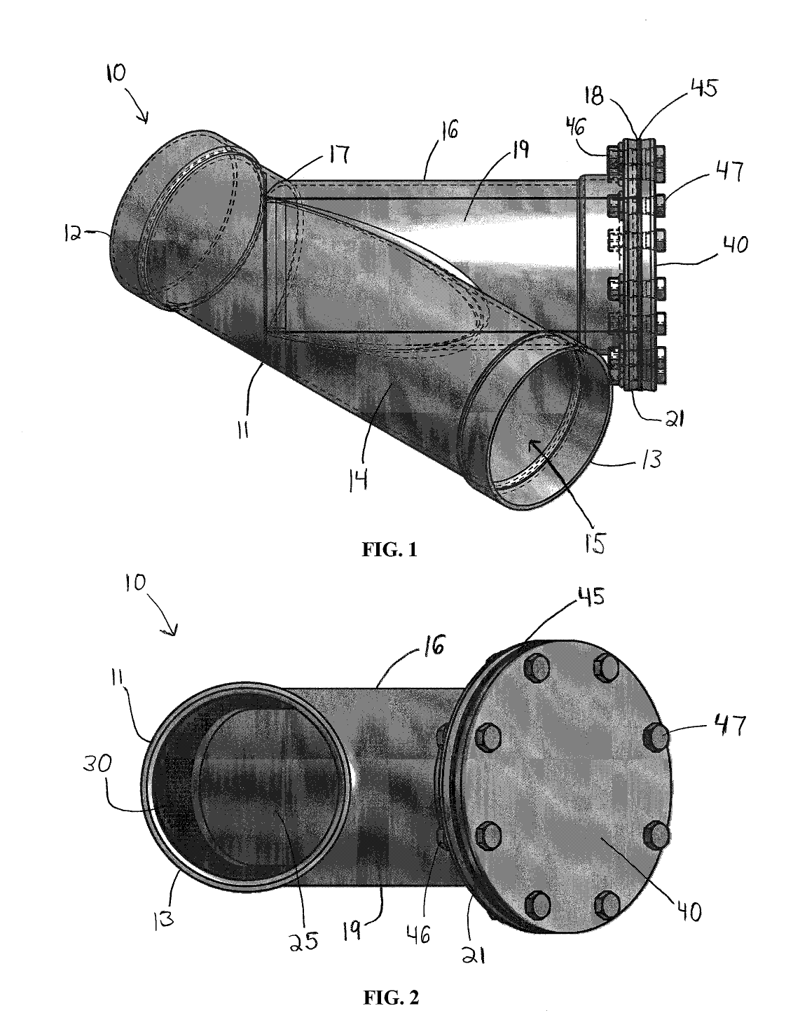

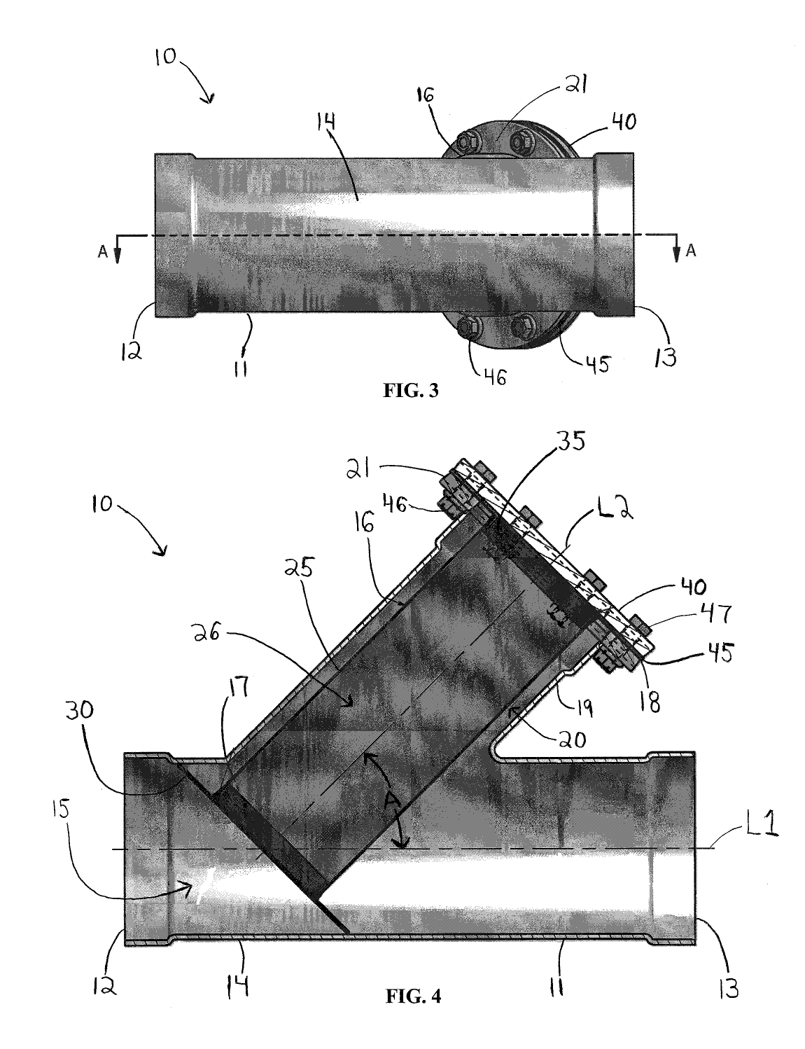

Referring to FIGS. 1-4, a strainer assembly 10 according to one preferred and non-limiting embodiment of the present invention is depicted. As shown, the strainer assembly 10 includes a first tubular body 11 extending along a first longitudinal axis L1 between a first open end 12 and a second open end 13. The first tubular body 11 includes a first annular sidewall 14 defining a first hollow internal cavity 15 within the first tubular body 11. A second tubular body 16 is integrally formed with or otherwise attached to the first tubular body 11 between the first 12 and second 13 open ends of the first tubular body 11. The second tubular body 16 extends along a second longitudinal axis L2 that is not parallel to, i.e. divergent from, the first longitudinal axis. The longitudinal axis L2 forms an angle A with the first longitudinal axis L1. As shown, the angle A is about 45°, although it is to be appreciated that the angle A between the respective longitudinal axes L1, L2 may be any suitable angle less than about 90°. For example, the angle A may be preferably in the range of about 10° to about 80°, more preferably in the range of about 30° to about 60°, and more preferably in the range of about 40° to about 50°.

The second tubular body 16 extends between a first open end 17 at least partially joined to the first sidewall 14 of the first tubular body 11 and a second open end 18. The second tubular body 16 includes a second annular sidewall 19 defining a second hollow internal cavity 20 within the second tubular body 16. As shown in FIG. 4, the second hollow internal cavity 20 is in communication with the first hollow internal cavity 15 through the first open end 17 of the second tubular body 16 and the first sidewall 14 of the first tubular body 11. The second tubular body 16 further includes an annular flange 21 disposed on the second end 18 of the second tubular body 16.

It is to be appreciated that the first 11 and second 16 tubular bodies may be formed from a variety of materials, including steel, brass, aluminum and stainless steel. The first 12 and second 13 open ends of the first tubular body 11 and the second open end 18 may also be belled in order to simplify fitting and welding with other tubular conduits. Further, the first 11 and second 16 tubular bodies may be formed from two opposing stamped metal halves that are subsequently secured by a longitudinal butt weld for increased strength. The annular flange 21 at the second end 18 of the second tubular body 16 may be formed from aluminum and separately welded to the second tubular body 16 after the two opposing stamped metal halves have been assembled to form the first 11 and second 16 tubular bodies.

With reference to FIGS. 2, 4, and 8, the strainer assembly 10 includes a cylindrical strainer basket 25 disposed within the second hollow internal cavity 20 of the second tubular body 16. As shown in FIG. 4, the basket 25 extends from the second end 18 of the second tubular body 16 into the first hollow cavity 15 of the first tubular body 11. As shown in FIG. 8, the cylindrical strainer basket 25 is formed from a length of screen material 26 arranged in a tubular configuration and having a plurality of perforations 27 to allow liquid to flow through the screen material 26 while trapping debris within the basket 25. It is to be appreciated that the cylindrical strainer basket 25 may be formed from a variety of materials, including brass and stainless steel, and may be arranged in many configurations known to be suitable to those of ordinary skill in the art.

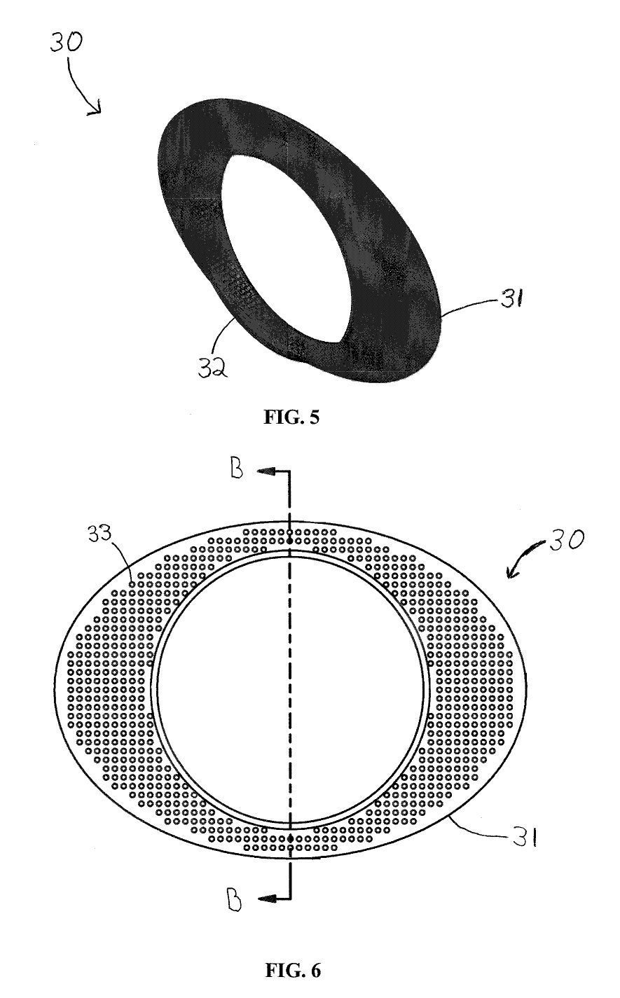

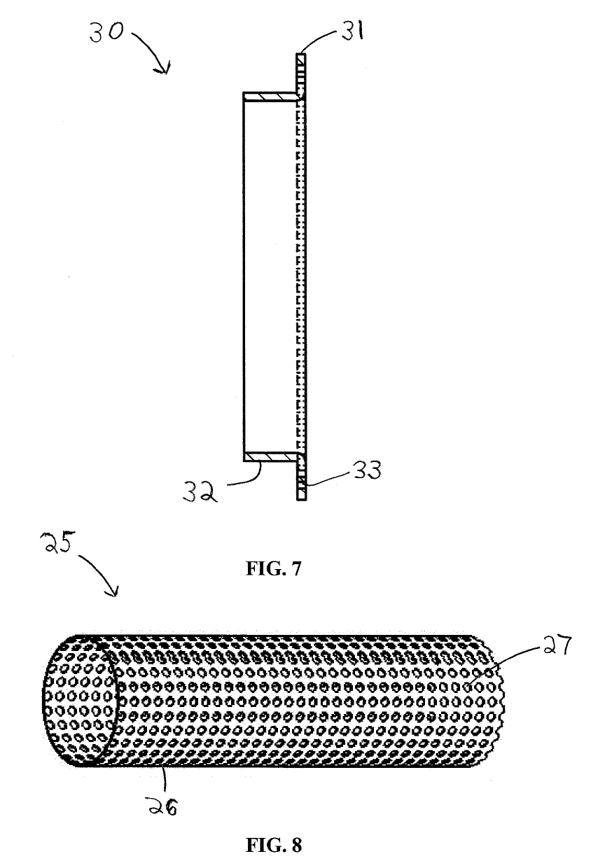

With reference to FIGS. 2 and 4-7, the strainer assembly 10 includes a retainer ring 30 disposed within the first internal hollow cavity 15 of the first tubular body 11 for maintaining the position of the cylindrical strainer basket 25 within the first tubular body 11. The retainer ring 30 has an elliptical face portion 31 that extends obliquely within the first internal hollow cavity 15 of the first tubular body 11, to engage an inner perimeter of the first sidewall 14, such that liquid cannot flow between the retainer ring 30 and the first sidewall 14. As shown in FIGS. 6 and 7, the elliptical face portion 31 of the retainer ring 30 has a plurality of perforations 33 formed therein, which correspond in size to the perforations 27 in the cylindrical strainer basket 25. Thus, the retainer ring 30 may also serve to strain the liquid flowing through the strainer assembly 10 in addition to the cylindrical strainer basket 25. By utilizing a retainer ring 30 with perforations 33, the present invention provides an increased flow area and provides 10-15% increase in flow, as compared to a stamped, straight strainer having a non-perforated retainer ring. The retainer ring 30 further includes a cylindrical sidewall portion 32 that extends transversely from a side of the elliptical face portion 31 of the retainer ring 30. The cylindrical sidewall portion 32 is fitted within and engages a first end of the cylindrical strainer basket 25, to maintain the position of the cylindrical strainer basket within the first internal hollow cavity 15 of the first tubular body 11.

It is to be appreciated that the retainer ring 30 may be formed from a variety of materials, including stainless steel, aluminum and brass, known to be suitable by those of ordinary skill in the art and may be sealingly engaged with the inner perimeter of the first sidewall 14 according to a variety of techniques, including welding, also known to be suitable by those of ordinary skill in the art. The perforations 33 in the elliptical face portion 31 of the retainer ring 30 match the size of the perforations 27 in the cylindrical strainer basket 25, and may be formed by a variety of techniques, including laser cutting and/or water jet cutting. Additionally, perforations 33 may also be formed in the cylindrical sidewall 32 of the retainer ring 30.

With reference to FIG. 4, the strainer assembly 10 further includes a cap retainer 35 disposed within the second hollow internal cavity 20 of the second tubular body 16 at the second end 18 of the second tubular body 16. The cap retainer 35 includes a cylindrical sidewall that is fitted within and engages a second end of the cylindrical strainer basket 25 in like manner to the cylindrical sidewall portion 32 of the retainer ring 30, to retain the second end of the cylindrical strainer basket 25 within the second hollow internal cavity 20 of the second tubular body 16.

With reference to FIGS. 1-4, the strainer assembly 10 also includes a blind flange 40 disposed on the second end 18 of the second tubular body 16 that is secured to the annular flange 21 of the second tubular body 16 by an attachment arrangement, such as a plurality of nuts 46 and bolts 47, to close the second hollow internal cavity 20 at the second end 18 of the second tubular body 16. A sealing gasket 45 is disposed between the blind flange 40 and the annular flange 21, to seal the engagement between the blind flange 40 and the annular flange 21 of the second tubular body 16 and in order to prevent leakage of liquid flowing through the strainer assembly 10. Additionally, the cap retainer 35 may be welded to the blind flange 40, to position the cap retainer 35 within the second tubular body 16.

With reference to FIGS. 1-4, during operation, the strainer assembly 10 will be connected along a conduit for transferring liquids. For instance, the strainer assembly 10 may be used in a line dispensing liquid fuels from a fuel truck to a vehicle, such as an aircraft or work vehicle. Liquid pumped through the conduit flows into the strainer assembly 10 and into the first hollow internal cavity 15 via the first open end 12 of the first tubular body 11. As liquid flows through the first tubular body 11, the liquid will pass upward towards the second hollow internal cavity 20 of the second tubular body 16 and into the cylindrical strainer basket 25. As the liquid passes through the perforations 27 in the screen material 26 of the basket 25, debris and other contaminants will be removed from the liquid by the basket 25. Additionally, liquid may flow through the perforations 33 in the elliptical face portion 31 of the retainer ring 30, which will also remove debris and other contaminants from the liquid. Thus, according to an embodiment of the present invention, both the cylindrical strainer basket 25 and the elliptical face portion 31 of the retainer ring 30 strain liquid flow through the strainer assembly 10. After passing through the strainer basket 25 and/or the elliptical face portion 31, the liquid returns to the first hollow internal cavity 15 and exits the strainer assembly 10 via the second open end 13 of the first tubular body 11.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A straight strainer assembly, comprising:
a first tubular body extending along a first longitudinal axis between a first open end and a second open end, the first tubular body having a first sidewall defining a first hollow internal cavity;
a second tubular body attached to the first tubular body between the first and second ends of the first tubular body, the second tubular body extending along a second longitudinal axis non-parallel with the first longitudinal axis, the second tubular body extending between a first open end joined to the sidewall of the first tubular body and a second open end, and the second tubular body having a second sidewall defining a second hollow internal cavity in communication with the first hollow internal cavity of the first tubular body;
a cylindrical strainer basket extending through the second hollow internal cavity from the second end of the second tubular body into the first hollow internal cavity; and
a retainer ring disposed within the first tubular body and having an elliptical face portion extending obliquely within the first tubular body.

2. The straight strainer assembly according to claim 1, wherein the second tubular body is integrally formed with the first tubular body between the first and second ends of the first tubular body.

3. The straight strainer assembly according to claim 1, wherein the retainer ring further includes a sidewall portion extending transversely from the elliptical face portion for at least partially engaging a first end of the cylindrical strainer basket within the first tubular body to maintain a position of the cylindrical strainer basket.

4. The straight strainer assembly according to claim 1, wherein the elliptical face portion of the retainer ring engages an inner perimeter of the first sidewall of the first tubular body.

5. The straight strainer assembly according to claim 1, wherein the second longitudinal axis forms an angle of less than about 90° with the first longitudinal axis.

6. The straight strainer assembly according to claim 1, wherein the second longitudinal axis forms an angle of less than about 80° and more than about 10° with the first longitudinal axis.

7. The straight strainer assembly according to claim 1, wherein the second longitudinal axis forms an angle of less than about 60° and more than about 30° with the first longitudinal axis.

8. The straight strainer assembly according to claim 1, wherein the second longitudinal axis forms an angle of less than about 50° and more than about 40° with the first longitudinal axis.

9. The straight strainer assembly according to claim 1, wherein the second longitudinal axis forms an angle of about 45° with the first longitudinal axis.

10. The straight strainer assembly according to claim 1, wherein
the second tubular body includes a flange disposed on the second end thereof and, wherein the assembly further comprises a blind flange secured to the flange of the second tubular body to close the second hollow internal cavity at the second end of the second tubular body; and
a gasket disposed between the flange on the second tubular body and the blind flange for sealing an engagement between the second tubular body and the blind flange.

11. The straight strainer assembly according to claim 1, wherein the cylindrical strainer basket is formed from a screen having perforations and arranged in a tubular configuration.

12. The straight strainer assembly according to claim 11, wherein the elliptical face portion of the retainer ring has perforations corresponding in size to the perforations in the screen of the cylindrical strainer basket.

13. The straight strainer assembly according to claim 1, further comprising a cap retainer disposed within the second tubular body at the second end thereof and engaging a second end of the cylindrical strainer basket to maintain the position of the cylindrical strainer basket.

14. The straight strainer assembly according to claim 1, wherein both the cylindrical strainer basket and the elliptical face portion of the retainer ring strain liquid flowing through the strainer assembly.

15. A retainer ring for maintaining a position of a strainer basket in a straight strainer, the retainer ring comprising:
an elliptical face portion adapted to extend obliquely within the straight strainer to engage an inner perimeter of the straight strainer; and
a sidewall portion extending transversely from the elliptical face portion adapted to engage the strainer basket within straight strainer to maintain a position of the cylindrical strainer basket,
wherein the elliptical face portion and the sidewall portion have perforations and are adapted to strain liquid flowing through the straight strainer.

16. The retainer ring according to claim 15, wherein the elliptical face portion of the retainer ring has perforations corresponding in size to perforations in the cylindrical strainer basket.

17. The retainer ring according to claim 15, wherein the elliptical face portion of the retainer ring is adapted to engage an inner perimeter of a sidewall of a tubular body of the straight strainer.

18. The retainer ring according to claim 15, wherein the retainer ring is made from a material chosen from the group consisting of: stainless steel, aluminum and brass.
